(19) United States
(12) Patent Application Publication
(10) Pub. No.: US 2005/0003897 A1
(43) Pub. Date: Jan. 6, 2005

(54) Method of manufacturing a combined driveshaft tube and yoke assembly

(76) Inventors: Nelson Wagner, Holland, OH (US); Matthew P. Blecke, Toledo, OH (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 10/882,462

(22) Filed: Jul. 1, 2004

Related U.S. Application Data
(60) Provisional application No. 60/484,087, filed on Jul. 1, 2003.

(51) Int. Cl. F16D 3/16; F16D 3/20

(52) U.S. Cl. 464/136

(57) ABSTRACT

A method for manufacturing a combined driveshaft tube and yoke assembly includes the initial step of providing a workpiece having a first portion defining a first wall thickness and a second portion defining a second wall thickness that is different from the first wall thickness. The first and second portions can be first and second sections that are separate from one another and joined together. Alternatively, the first and second portions can be formed integrally with one another. A pair of yoke arms having respective openings therethrough are formed in the first portion of the workpiece to provide a combined driveshaft tube and yoke assembly. A bearing bushing may be disposed in each of the openings. Alternatively, the yoke arms can have respective flanged openings formed therethrough.

### CROSS-REFERENCE TO RELATED APPLICATIONS

This application claims the benefit of U.S. Provisional Application No. 60/484,087, filed Jul. 1, 2003, the disclosure of which is incorporated herein by reference.

### BACKGROUND OF THE INVENTION

This invention relates in general to drive train systems for transferring rotational power from a source of rotational power to a rotatably driven mechanism. In particular, this invention relates to an improved method for manufacturing a combined driveshaft tube and yoke assembly for use in such a drive train system.

Drive train systems are widely used for generating power from a source and for transferring such power from the source to a driven mechanism. Frequently, the source generates rotational power, and such rotational power is transferred from the source to a rotatably driven mechanism. For example, in most land vehicles in use today, an engine/transmission assembly generates rotational power, and such rotational power is transferred from an output shaft of the engine/transmission assembly through a driveshaft assembly to an input shaft of an axle assembly so as to rotatably drive the wheels of the vehicle. To accomplish this, a typical driveshaft assembly includes a hollow cylindrical driveshaft tube having a pair of end fittings, such as a pair of tube yokes, secured to the front and rear ends thereof. The front end fitting forms a portion of a front universal joint that connects the output shaft of the engine/transmission assembly to the front end of the driveshaft tube. Similarly, the rear end fitting forms a portion of a rear universal joint that connects the rear end of the driveshaft tube to the input shaft of the axle assembly. The front and rear universal joints provide a rotational driving connection from the output shaft of the engine/transmission assembly through the driveshaft assembly to the input shaft of the axle assembly, while accommodating a limited amount of angular misalignment between the rotational axes of these three shafts.

As mentioned above, a typical driveshaft assembly includes a hollow cylindrical driveshaft tube having a pair of end fittings, such as a pair of tube yokes, secured to the front and rear ends thereof. Traditionally, the tube yokes have been formed by forging or casting and have been secured to the ends of the driveshaft by welding or adhesives. Although this method has been effective, it would be desirable to provide an improved method for manufacturing a combined driveshaft tube and yoke assembly for use in a drive train system that avoids the use of welding or adhesives.

### SUMMARY OF THE INVENTION

This invention relates to an improved method for manufacturing a combined driveshaft tube and yoke assembly, such as for use in a vehicular drive train system. Initially, a workpiece having a first portion defining a first wall thickness and a second portion defining a second wall thickness that is different from the first wall thickness is provided. The first and second portions can be first and second sections that are separate from one another and joined together. Alternatively, the first and second portions can be formed integrally with one another. A pair of yoke arms having respective openings therethrough are formed in the first portion of the workpiece to provide a combined driveshaft tube and yoke assembly. A bearing bushing may be disposed in each of the openings. Alternatively, the yoke arms can have respective flanged openings formed therethrough.

Various objects and advantages of this invention will become apparent to those skilled in the art from the following detailed description of the preferred embodiments, when read in light of the accompanying drawings.

### BRIEF DESCRIPTION OF THE DRAWINGS

FIG. 1 is a perspective view of a workpiece that can be used to form a combined driveshaft tube and yoke assembly in accordance with a first embodiment of the method of this invention.

FIG. 2 is a sectional elevational view of the workpiece illustrated in FIG. 1.

FIG. 3 is a perspective view similar to FIG. 1 showing the workpiece after an initial deformation step has been completed.

FIG. 4 is a sectional elevational view of the workpiece illustrated in FIG. 3.

FIG. 5 is a perspective view similar to FIG. 3 showing the workpiece after a material removing process has been performed to provide first and second yoke arms having respective openings formed therethrough.

FIG. 6 is a sectional elevational view of the workpiece illustrated in FIG. 5.

FIG. 7 is a perspective view similar to FIG. 5 showing the workpiece after first and second inserts have been disposed within the first and second openings.

FIG. 8 is a sectional elevational view of the workpiece illustrated in FIG. 7.

FIG. 9 is a perspective view similar to FIG. 3 showing the workpiece after first and second flanged openings have been formed through an end thereof.

FIG. 10 is a sectional elevational view of the workpiece illustrated in FIG. 9.

FIG. 11 is a perspective view of a workpiece that can be used to form a combined driveshaft tube and yoke assembly in accordance with a second embodiment of the method of this invention.

FIG. 12 is a sectional elevational view of the workpiece illustrated in FIG. 11.

FIG. 13 is a perspective view similar to FIG. 11 showing the workpiece after an initial deformation step has been completed.

FIG. 14 is a sectional elevational view of the workpiece illustrated in FIG. 13.

FIG. 15 is a perspective view similar to FIG. 13 showing the workpiece after a material removing process has been performed to provide first and second yoke arms having respective openings formed therethrough.

FIG. 16 is a sectional elevational view of the workpiece illustrated in FIG. 15.

### DETAILED DESCRIPTION OF THE PREFERRED EMBODIMENTS

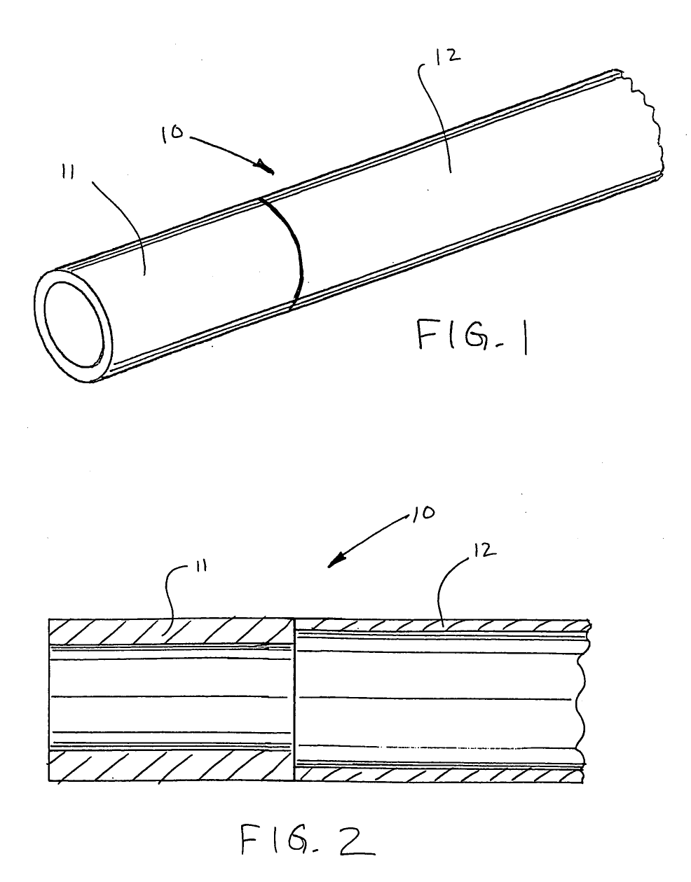

Referring now to the drawings, there is illustrated in FIG. 1 a workpiece, indicated generally at 10, that can be used to form a combined driveshaft tube and yoke assembly in accordance with a first embodiment of the method of this invention. The workpiece 10 is generally hollow and cylindrical in shape and is formed from two hollow cylindrical sections 11 and 12 that are joined together in an end-to-end manner in any conventional manner, such as by welding. However, the workpiece 10 and the first and second sections 11 and 12 thereof can be provided having any desired shape or shapes. In the illustrated embodiment, the two sections 11 and 12 have the same outer diameter so that the outer diameter of the workpiece 10 is generally constant. However, the outer diameters of the two sections 11 and 12 may differ from one another as desired. As best shown in FIG. 2, the wall thicknesses of the first and second sections 11 and 12 differ from one another. In the illustrated embodiment, the wall thickness of the first section 11 is greater than the wall thickness of the second section 12. However, if desired, the wall thickness of the second section 12 may be greater than the wall thickness of the first section 11.

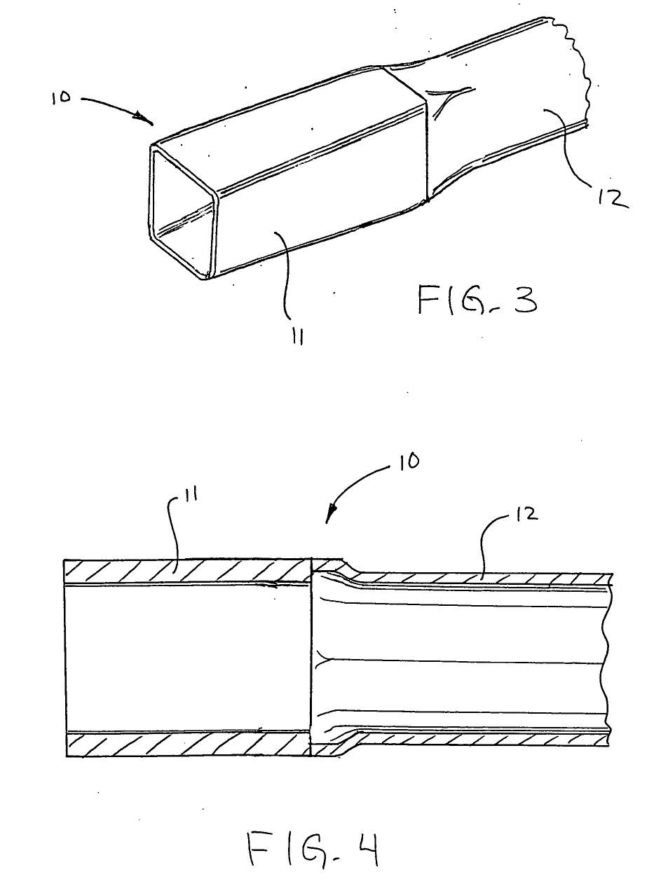

FIGS. 3 and 4 illustrate the workpiece 10 after it has been subjected to an initial deformation process to re-shape it to a desired configuration. As shown therein, the first section 11 of the deformed workpiece 10 has been re-shaped to have a generally rectangular cross sectional shape relative to the generally circular cross sectional shape of the second section 12. However, the first section 11 of the deformed workpiece 10 can be re-shaped to have any desired shape. Preferably, the workpiece 10 is formed from a metallic material that is suitable for deformation by any of a variety of well know metal deformation techniques, such as by hydroforming, magnetic pulse forming, and the like. However, the workpiece 10 may be formed from any desired material that is capable of being re-shaped in a desired manner and can be re-shaped using any desired process.

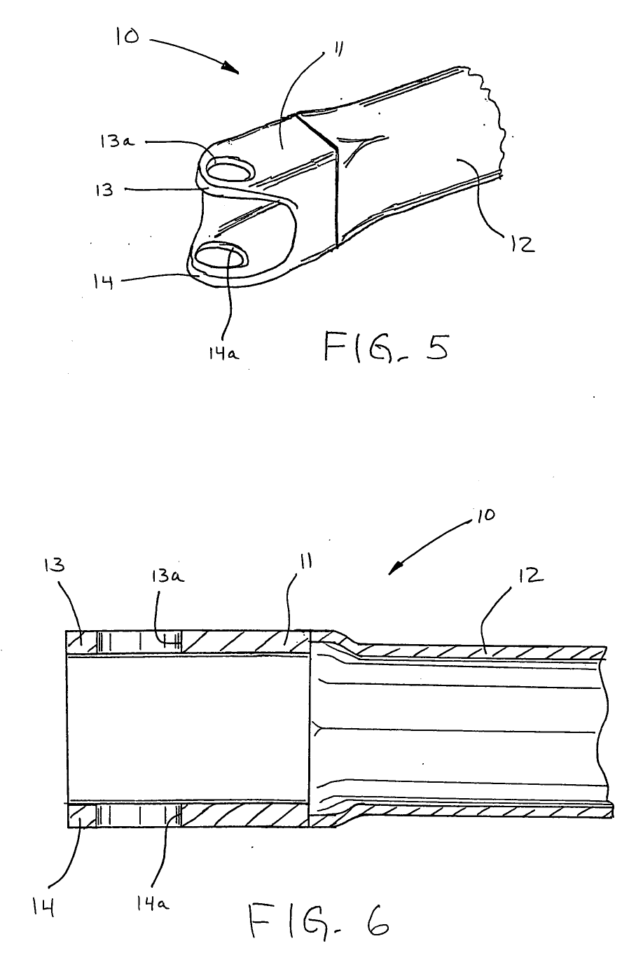

Following the initial deformation process as described above, the workpiece 10 is subjected to a material removing process to provide first and second yoke arms 13 and 14 having respective openings 13a and 14a formed therethrough, as shown in FIGS. 5 and 6. In the illustrated embodiment, portions of the end of the first section 11 have been removed to define the yoke arms 13 and 14. The removal of these portions of the end of the first section 11 can be accomplished by any desired material removing process, such as by laser cutting or mechanical machine cutting. As a result such cuttings, the workpiece 10 is provided with the pair of opposed yoke arms 13 and 14. Also, in the illustrated embodiment, portions of the yoke arms 13 and 14 have been removed to define the openings 13a and 14a. The removal of these portions of the two yoke arms 13 and 14 can also be accomplished by any desired material removing process, such as by laser cutting or mechanical machine cutting. As a result such cuttings, the opposed yoke arms 13 and 14 are provided with the pair of aligned openings 13a and 14a. Thus, the workpiece 10 is a combined driveshaft tube and yoke assembly.

Following its formation in the manner described above, the combined driveshaft tube and yoke assembly 10 can be subjected to one or more finishing operations to precisely define the shape thereof. When finished, the combined driveshaft tube and yoke assembly 10 can function as a conventional combined driveshaft and yoke assembly. For example, two of such combined driveshaft tube and yoke assemblies 10 can be connected together by a conventional universal joint cross (not shown) to provide two driveshaft sections having a rotational driving connection therebetween that can accommodate a limited amount of angular misalignment between the rotational axes thereof. Typically, the cross includes a central body portion with four cylindrical trunnions extending outwardly therefrom. The trunnions are oriented in a single plane and extend at right angles relative to one another. A hollow cylindrical bearing cup is mounted on the end of each of the trunnions. Needle bearings or other friction-reducing structures are provided between the outer cylindrical surfaces of the trunnions and the inner cylindrical surfaces of the bearing cups to permit rotational movement of the bearing cups relative to the trunnions during operation of the universal joint. The bearing cups supported on the first opposed pair of the trunnions on the cross can be received within the aligned openings 13a and 14a formed through the yoke arms 13 and 14 of the first combined driveshaft tube and yoke assembly 10, while the bearing cups supported on the second opposed pair of the trunnions on the cross can be received within the aligned openings 13a and 14a formed through the yoke arms 13 and 14 of the second combined driveshaft tube and yoke assembly 10.

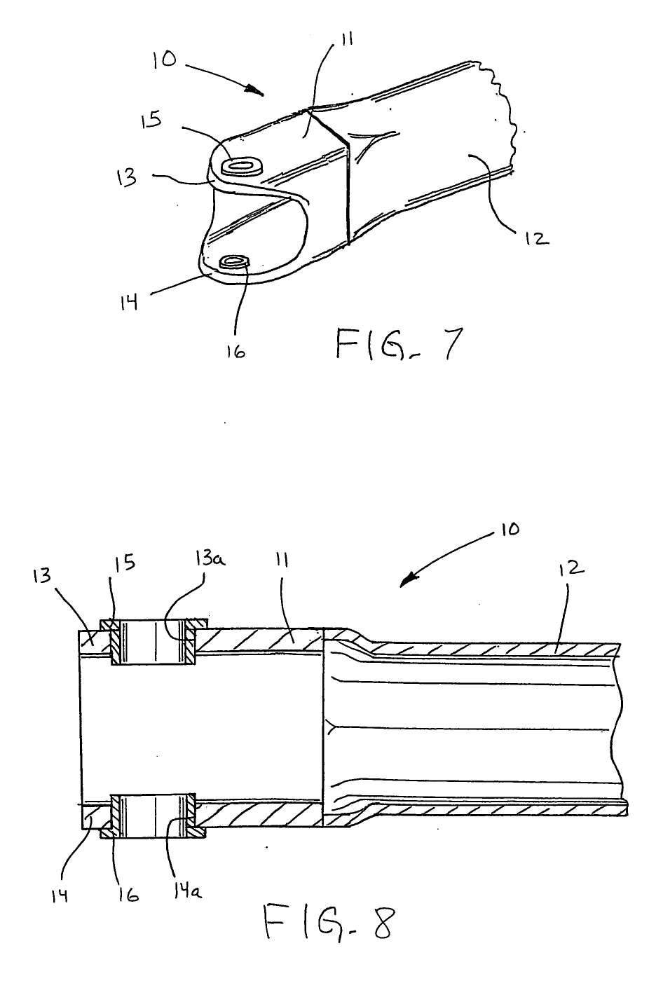

FIGS. 7 and 8 illustrate a first alternative structure for the combined driveshaft tube and yoke assembly 10′ after being formed in the manner described above. The first alternative combined driveshaft tube and yoke assembly 10′ is, in large measure, identical to the combined driveshaft tube and yoke assembly 10 described above, and like reference numbers are used to indicate similar structures. In this instance, a bearing bushing 15 and 16 is disposed within each of the openings 13a and 14a to receive and support the bearing cups of the universal joint cross, as described above.

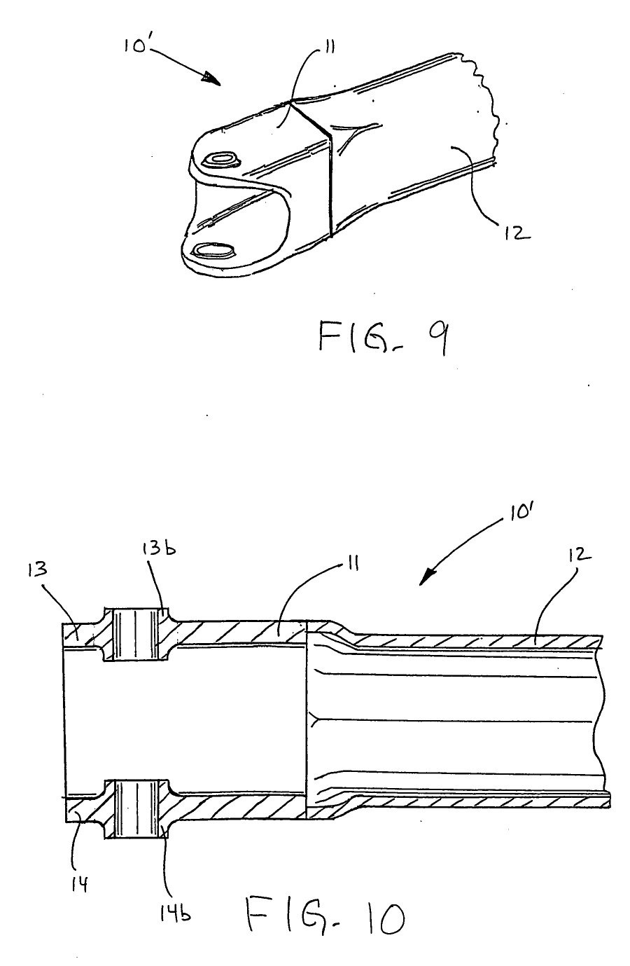

FIGS. 9 and 10 illustrate a second alternative structure for the combined driveshaft tube and yoke assembly 10″ after being formed in the manner described above. The second alternative combined driveshaft tube and yoke assembly 10″ is also, in large measure, identical to the combined driveshaft tube and yoke assembly 10 described above, and like reference numbers are used to indicate similar structures. In this instance, the first and second yoke arms 13 and 14 having respective flanged openings 13b and 14b formed therethrough, instead of the simple openings 13a and 14a described above. The flanged openings 13b and 14b can be formed using any desired process, such as by a conventional flow drilling process. The flanged openings 13b and 14b can directly receive and support the bearing cups of the universal joint cross, as described above.

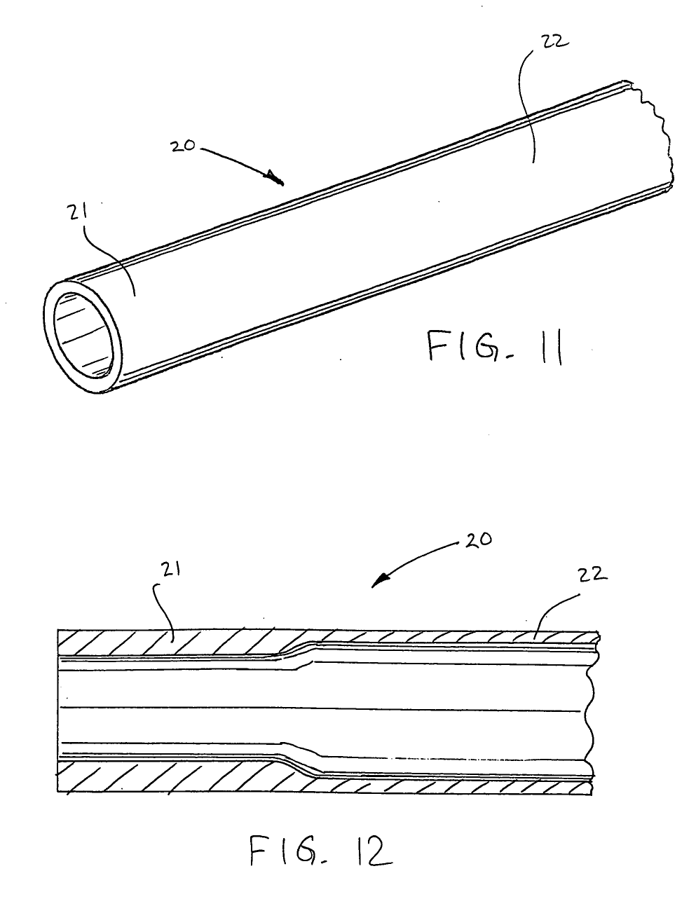

Referring now to the FIGS. 11 through 16, there is illustrated a workpiece, indicated generally at 20, that can be used to form a combined driveshaft tube and yoke assembly in accordance with a second embodiment of the method of this invention. The workpiece 20 is generally hollow and cylindrical in shape and is formed from two hollow cylindrical portions 21 and 22 (see FIG. 12) that are formed integrally with one another. However, the workpiece 20 and the first and second portions 21 and 22 thereof can be provided having any desired shape or shapes. In the illustrated embodiment, the two portions 21 and 22 have the same outer diameter so that the outer diameter of the workpiece 20 is generally constant. However, the outer diameters of the two portions 21 and 22 may differ from one another as desired. As best shown in FIG. 12, the wall thicknesses of the first and second portions 21 and 22 differ from one another. In the illustrated embodiment, the wall thickness of the first portion 21 is greater than the wall thickness of the second portion 22. However, if desired, the wall thickness of the second portion 22 may be greater than the wall thickness of the first portion 21.

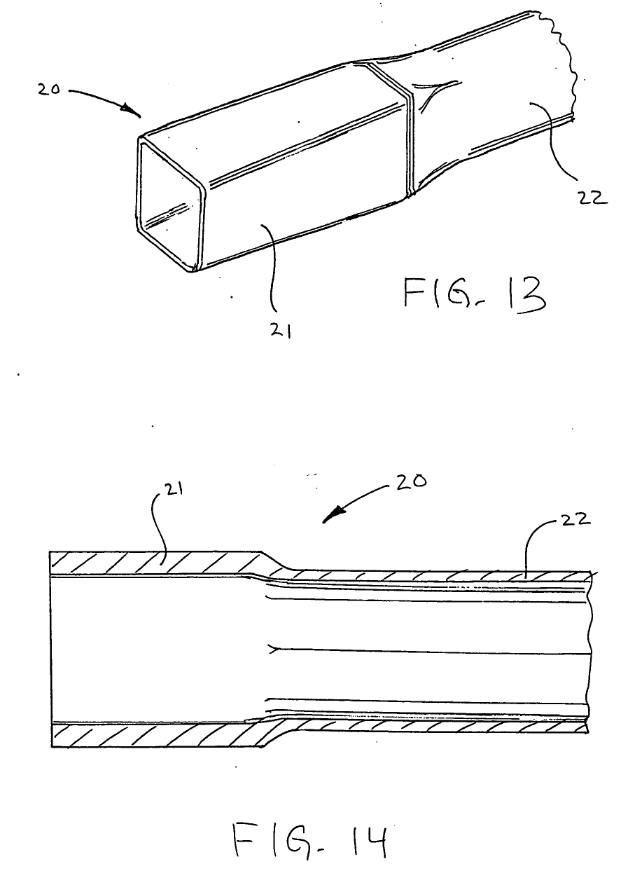

FIGS. 13 and 14 illustrate the workpiece 20 after it has been subjected to an initial deformation process to re-shape it to a desired configuration. As shown therein, the first portion 21 of the deformed workpiece 20 has been re-shaped to have a generally rectangular cross sectional shape relative to the generally circular cross sectional shape of the second portion 22. However, the first portion 21 of the deformed workpiece 20 can be re-shaped to have any desired shape. Preferably, the workpiece 20 is formed from a metallic material that is suitable for deformation by any of a variety of well know metal deformation techniques, such as by hydroforming, magnetic pulse forming, and the like. However, the workpiece 20 may be formed from any desired material that is capable of being re-shaped in a desired manner and can be re-shaped using any desired process.

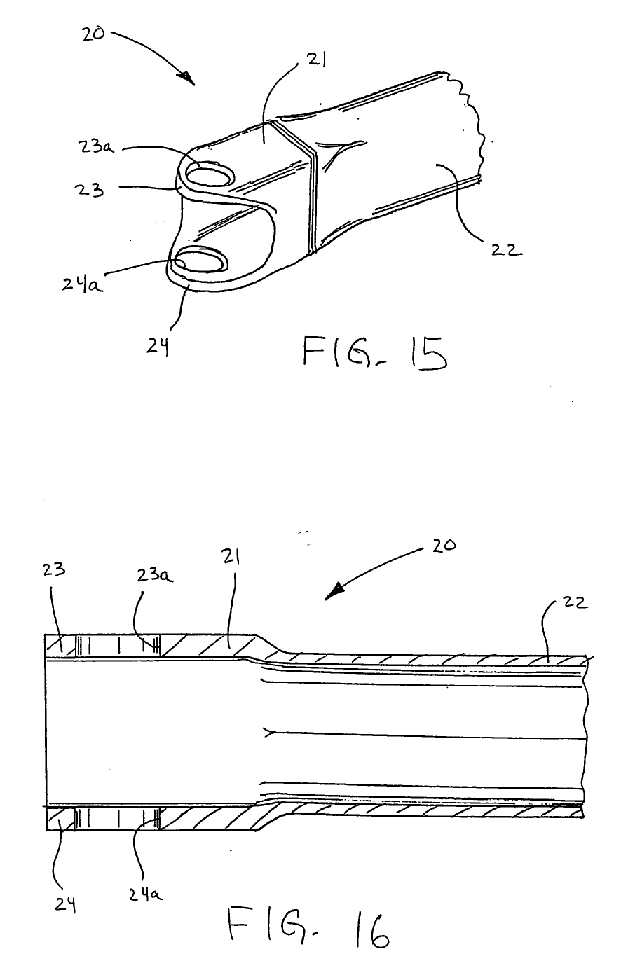

Following the initial deformation process as described above, the workpiece 20 is subjected to a material removing process to provide first and second yoke arms 23 and 24 having respective openings 23a and 24a formed therethrough, as shown in FIGS. 15 and 16. In the illustrated embodiment, portions of the end of the first portion 21 have been removed to define the yoke arms 23 and 24. The removal of these portions of the end of the first portion 21 can be accomplished by any desired material removing process, such as by laser cutting or mechanical machine cutting. As a result such cuttings, the workpiece 20 is provided with the pair of opposed yoke arms 23 and 24. Also, in the illustrated embodiment, portions of the yoke arms 23 and 24 have been removed to define the openings 23a and 24a. The removal of these portions of the two yoke arms 23 and 24 can also be accomplished by any desired material removing process, such as by laser cutting or mechanical machine cutting. As a result such cuttings, the opposed yoke arms 23 and 24 are provided with the pair of aligned openings 23a and 24a. Thus, the workpiece 20 is a combined driveshaft tube and yoke assembly.

Following its formation in the manner described above, the combined driveshaft tube and yoke assembly 20 can be subjected to one or more finishing operations to precisely define the shape thereof. When finished, the combined driveshaft tube and yoke assembly 20 can function as a conventional combined driveshaft and yoke assembly in the manner described above. Additionally, bearing bushings (not shown) may be disposed within each of the openings 23a and 24a to receive and support the bearing cups of the universal joint cross, as described above. Alternatively, the first and second yoke arms 23 and 24 may have respective flanged openings (not shown) formed therethrough as described above.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A method for manufacturing a combined driveshaft tube and yoke assembly comprising the steps of:
(a) providing a workpiece having a first portion defining a first wall thickness and a second portion defining a second wall thickness that is different from the first wall thickness; and
(b) forming a pair of yoke arms having respective openings therethrough in the first portion of the workpiece to provide a combined driveshaft tube and yoke assembly.

2. The method defined in claim 1 wherein said step (a) is performed by providing the first portion as a first section defining the first wall thickness and by providing the second portion as a second section defining the second wall thickness, wherein the first and second sections are separate from one another.

3. The method defined in claim 2 wherein said step (a) is further performed by joining the first and second sections together.

4. The method defined in claim 1 wherein said step (a) is performed by forming the first and second portions integrally with one another.

5. The method defined in claim 1 wherein said step (b) is performed by providing a hollow workpiece and deforming the workpiece by one of hydroforming and magnetic pulse forming to re-shape the first portion.

6. The method defined in claim 1 wherein said step (a) is performed by providing the first wall thickness to be greater than the second wall thickness.

7. The method defined in claim 1 wherein said step (a) is performed by providing a workpiece having an outer diameter that is generally constant.

8. The method defined in claim 1 wherein said step (b) includes the further steps of disposing a bearing bushing in each of the openings.

9. The method defined in claim 1 wherein said step (b) is performed by forming the pair of yoke arms having respective flanged openings therethrough.
